(19) United States
(12) Patent Application Publication
(10) Pub. No.: US 2015/0128919 A1
(43) Pub. Date: May 14, 2015

(54) ADJUSTABLE FUEL MIXTURE

(71) Applicant: Michaal Ibrahim, Issaquah, WA (US)

(72) Inventor: Michaal Ibrahim, Issaquah, WA (US)

(21) Appl. No.: 14/080,763

(22) Filed: Nov. 14, 2013

(51) Int. Cl. F02M 21/02

(52) U.S. Cl. CPC F02M 21/02
USPC 123/575

(57) ABSTRACT

Method and system are disclosed for mixing and using different combustible fuels to run combustion engines such as gasoline, diesel, or turbo-charged engines of cars, trucks, boats, airplanes, and the like. In various embodiments the mixture components and their proportions may be different or may be manually, dynamically and/or automatically controlled and adjusted.

### TECHNICAL FIELD

This application relates generally to combustible fuel. More specifically, this application relates to methods and systems of mixing different types of readily available automotive fuels for economical and efficient performance of engines.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description mostly references using gasoline and diesel fuel, it will be appreciated that the disclosure may include many other synthetic or natural fuel materials such as ethanol and the like.

Briefly described, methods and systems are disclosed for mixing and using different combustible fuels to run combustion engines of cars, trucks, boats, airplanes, and the like. In various embodiments, the mixture components and their proportions may be different or may be dynamically controlled and adjusted. The price of gas is rising almost on a daily basis and customers, such as automobile owners, feel forced into using a specific type and grade of fuel to run their transportation and other equipment. While the mixing of readily available fuels may not be ideal for achieving certain performance goals, it will offer compromises between cost, power, performance, gas-mileage, engine and power train wear, engine noise, and other important factors involved in owning and operating gas-engine transportation machines.

In one exemplarily embodiment, gasoline and diesel fuel are mixed to run gasoline operated auto-engines. In this embodiment, for example, 50% gasoline and 50% diesel fuel or 60% gasoline and 40% diesel fuel may be used. In some embodiments the fuels may be premixed with a certain ratio which may not be changed during the engine operation. Generally, two or more fuel components may be mixed according to a definite proportion for each component, which proportion may maximize or optimize one or more particular performance aspects of the mixture. For example, gasoline, diesel, and ethanol may be mixed in proportions of 50%, 35%, and 15%, respectively, to reduce the overall cost of the mixture and reduce engine wear while maintaining the power output near that of gasoline alone. In other embodiments the mixture's components and ratios may be dynamically and automatically or manually changed, according to some feedback or criteria.

In various embodiments, the ratio may be changed based on feedback data related to a performance parameter of interest, such as gas mileage, power output, noise, and the like. Various performance parameters may be measured by sensors and displayed to the driver via a dashboard display console. The user may have the option to change such ratios directly using one or more control buttons on the console or set the desired level of performance parameter and let a fuel mixture control system automatically adjust the mixture, for example, by controlling fuel valves or separate fuel injection ports, until the selected performance parameter reaches its desired level. This process is similar to adjusting the heater in a car, where in some cars the user can turn up the heat using a knob, while in other cars the user simply sets a desired temperature, such as 70° F. and then the heating control system of the car adjusts the heat input into the cab area until the set temperature is reached. Similarly, a user may set the mileage to 25 MPG (Miles Per Gallon) and the fuel mixture control system will adjust the mixture continuously until the desired mileage is reached.

Those skilled in the art will appreciate that with the use of microprocessors, sensors such as pressure sensors, torque sensors, speed sensors, oxygen sensors, temperature sensors and many other types of sensors, many parameters such as gas mileage, relative cost, power output, and the like, may be calculated and displayed. Also, with the use of actuators and valve controllers, the input of fuel components into the mixture may be controlled.

In an embodiment of a simple fuel mixing system, a user, such as a car driver, may manually fill-up his gas-tank with, for example, equal amounts of gasoline and diesel fuel or gasoline, diesel fuel, and ethanol. In another embodiment the user may be provided with a special gas pump which can be easily programmed, for example, by a few key-strokes to mix a number of fuels with desired ratios. The user, based on her experience, experiments, or study, may decide to fill-up her tank by a specific mixture for a specific occasion, such as driving over a mountain or going on a long distance trip.

In various embodiments a car may have more than one gas tank for different kinds of fuels and may dynamically mix two or more of those fuels based on a preprogrammed feedback control system to maximize, minimize, or optimize certain output or performance parameter of the car. In other embodiments, this feedback system may be preprogrammed by the manufacturer and the user may have the choice to use more than one mixing program as needed. In yet other embodiments the user may be able to override or completely shut-down the automatic feedback system or be even able to program it herself based on different desired criteria.

In yet other embodiments, the user may be able to dynamically and manually change the mixture parameters as desired. This may be accomplished simply by having a knob for each fuel tank or a touch-screen for entering and changing the mixture parameters.

Those skilled in the art will appreciate that many other types of fuel mixtures and open and closed loop control systems are possible without departing from the spirit of the present disclosures. For example, an automobile may be preprogrammed by the manufacturer to use a single high octane fuel for initial acceleration, another mixture for cruising, and a third mixture while the motor experiences excessive loads such as climbing steep roads. All fuels mentioned in this disclosure may be fuels readily available in gas stations throughout United States or gas stations of other countries. In various embodiments the gas mixture components may be mixed by the gas dispensing machine at the gas stations and be sold to the users premixed.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

1. A method of supplying a combustion engine with fuel, the method comprising:
providing a first type of fuel;
providing at least a second type of fuel;
mixing the first type of fuel with the at least second type of fuel according to a predetermined mixture ratio; and
supplying the combustion engine with the mixture of fuels.

2. The method of claim 1, wherein the first type of fuel is gasoline.

3. The method of claim 1, wherein the second type of fuel is diesel fuel.

4. The method of claim 1, wherein a third type of fuel is mixed with the first and the second types of fuels which is ethanol.

5. The method of claim 1, wherein the mixing is accomplished in a gas tank from which the engine is fed.

6. The method of claim 1, wherein the mixing is accomplished prior to entering the engine.

7. (canceled)

8. (canceled)

9. The method of claim 1, wherein a closed-loop automatic control system controls the mixing of the fuels.

10. The method of claim 1, wherein an open-loop control system controls the mixing of the fuels.

11. The method of claim 1, wherein mixing parameters are configured to be changed dynamically, manually, or both.

12. A gas-engine operated machine comprising:
a first fuel tank for storing a first fuel type;
a second fuel tank for storing a second fuel type; and
a mixer component to controllably mix the first and the second fuel types, prior to entering the gas-engine, to be used by the gas-engine, wherein the control of mixing process is manual, dynamic, automatic, open-loop, closed-loop, or a combination thereof.

13. The machine of claim 12, wherein the fuels are the fuels available at United States gas stations.

14. The machine of claim 12, wherein the first type of fuel is gasoline.

15. The machine of claim 12, wherein the second type of fuel is diesel fuel.

16. The machine of claim 12, wherein the machine is a car.

17. (canceled)

18. (canceled)

19. The machine of claim 12, wherein mixing control is programmable.

20. The machine of claim 12, wherein mixing control is preprogrammed by manufacturer.
